(19) United States
(12) Patent Application Publication
(10) Pub. No.: US 2011/0115232 A1
(43) Pub. Date: May 19, 2011

(54) VERTICAL AXIS WIND TURBINE WITH FLAT ELECTRIC GENERATOR

(75) Inventor: Jack vanderDeen, Burlington (CA)

(73) Assignee: TWO-WEST WIND AND SOLAR INC., Ancaster (CA)

(21) Appl. No.: 12/620,022

(22) Filed: Nov. 17, 2009

(51) Int. Cl. F03D 9/00; H02K 21/24; H02K 7/102

(52) U.S. Cl. 290/55; 310/156.37; 310/77

(57) ABSTRACT

A wind turbine with an electric generator, having a vertical axis of rotation, the wind turbine having: a cantilevered spindle having an upper end and a lower base for securing to a support structure, the spindle having an electric generator stator disposed about the spindle in communication with electrical conductors; a rotor assembly comprising a sleeve and a rotor housing mounted coaxially around the spindle and the stator for rotation about the vertical axis, the rotor housing having a number of permanent magnets disposed about the stator mounted in the rotor housing, the rotor assembly including rotor bearings mounting the rotor housing to the spindle; and a number of blades mounted to the rotor housing, the electric generator optionally having: a stator having a first annular flux surface and a second annular flux surface transverse the axis of rotation and a plurality of armature sections disposed in a circumferential array wherein each armature section has metal wire coils in communication with electrical conductors, the stator being fixed to a spindle; a rotor assembly comprising a rotor housing enveloping the stator, the rotor assembly having a first annular permanent magnet array and a second annular permanent magnet array mounted in the rotor housing adjacent the first flux surface and the second flux surface respectively, the rotor housing connected to a sleeve mounted on the spindle for rotation about the axis; wherein each armature section comprises a bobbin segment about which at least one of the metal wire coils are wound, the bobbin segment including a mounting lug and fastener engageable with a matching contact pad in a stator hub.

### TECHNICAL FIELD

The invention relates to vertical axis wind turbine with an electric generator, preferably a flat generator with an annular stator enveloped in a rotor housing.

### BACKGROUND OF THE ART

The generation of electricity from renewable energy sources such as wind is of interest not only to electrical utilities. Business managers and home owners are increasingly interested in adopting such technologies that lower electrical costs, enable independent generation of electricity, reduce pollution, and ideally generate a profit.

Vertical axis windmills or wind turbines have the advantage over horizontal axis windmills that they do not depend on wind direction and need not include any directing mechanism. Low cost manufacture, minimal maintenance and minimal operating expertise are desirable especially when businesses and home owners purchase a wind powered generator. While electrical utilities have highly specialized operating and maintenance staff, businesses and home owners have different needs and expectations of the equipment they purchase. Highly reliable, simple, low cost equipment is necessary to achieve commercial success in the general business and home owner market.

Many conventional wind turbines or windmills available presently are either too large capacity, too mechanically complex or too high cost for any customer other than an electrical utility or a large commercial enterprise with the financial resources and technical expertise to properly operate and maintain such major pieces of equipment. An example is shown in WO 92/08893. Conventional wind mills or wind turbines that are within the reach of the general business and home owner market are often do-it-yourself kits, experimental or hobby projects for enthusiasts, and are not suitable for large scale adoption by the general business or consumer market.

Conventional flat electric generators also suffer from complex manufacturing requirements and relatively high cost as a result of failing to achieve levels of sales where economies of scale are realized. Example generators in the prior art are described in U.S. Pat. No. 4,565,938 to Fawzy and U.S. Pat. No. 6,794,783 to Tu et al.

Features that distinguish the present invention from the background art will be apparent from review of the disclosure, drawings and description of the invention presented below.

### DISCLOSURE OF THE INVENTION

The invention provides a wind turbine with an electric generator, having a vertical axis of rotation, the wind turbine having: a cantilevered spindle having an upper end and a lower base for securing to a support structure, the spindle having an electric generator stator disposed about the spindle in communication with electrical conductors; a rotor assembly comprising a sleeve and a rotor housing mounted coaxially around the spindle and the stator for rotation about the vertical axis, the rotor housing having a number of permanent magnets disposed about the stator mounted in the rotor housing, the rotor assembly including rotor bearings mounting the rotor housing to the spindle; and a number of blades mounted to the rotor housing.

The invention further provides an electric generator having an axis of rotation comprising: a stator having a first annular flux surface and a second annular flux surface transverse the axis of rotation and a plurality of armature sections disposed in a circumferential array wherein each armature section has metal wire coils in communication with electrical conductors, the stator being fixed to a spindle; a rotor assembly comprising a rotor housing enveloping the stator, the rotor assembly having a first annular permanent magnet array and a second annular permanent magnet array mounted in the rotor housing adjacent the first flux surface and the second flux surface respectively, the rotor housing connected to a sleeve mounted on the spindle for rotation about the axis; wherein each armature section comprises a bobbin segment about which at least one of the metal wire coils are wound, the bobbin segment including a mounting lug and fastener engageable with a matching contact pad in a stator hub.

### DESCRIPTION OF THE DRAWINGS

In order that the invention may be readily understood, one embodiment of the invention is illustrated by way of example in the accompanying drawings.

FIG. 1 is an isometric view of an embodiment of the invention showing a vertical axis wind turbine with a portion of the exterior sleeve cut away to show the interior spindle, the sleeve supporting two tiers of blades, the spindle having a base (foundation or support structure not shown), and a flat electric generator at the top.

FIG. 2 is a vertical sectional view through the electric generator along the central axis of rotation.

FIG. 3 is an isometric view of a partially disassembled generator (fully assembled in FIG. 2) showing the stator with annular array of armature sections and the lower shell of the rotor housing with annular array of permanent magnets housed therein.

FIG. 4 is a detail isometric view of the stator with wire windings removed to show the mounting lugs by which the wire coils are secured to the stator hub with removable fasteners.

FIG. 5 is an isometric view of two brake shoes pivotally mounted to the underside of the stator hub.

FIG. 6 is an isometric view of the base shown in FIG. 1 to show details of the rollers that act as bearings to allow rotation of the rotor assembly while accommodating deflections under loading.

Further details of the invention and its advantages will be apparent from the detailed description included below.

### DETAILED DESCRIPTION OF PREFERRED EMBODIMENTS

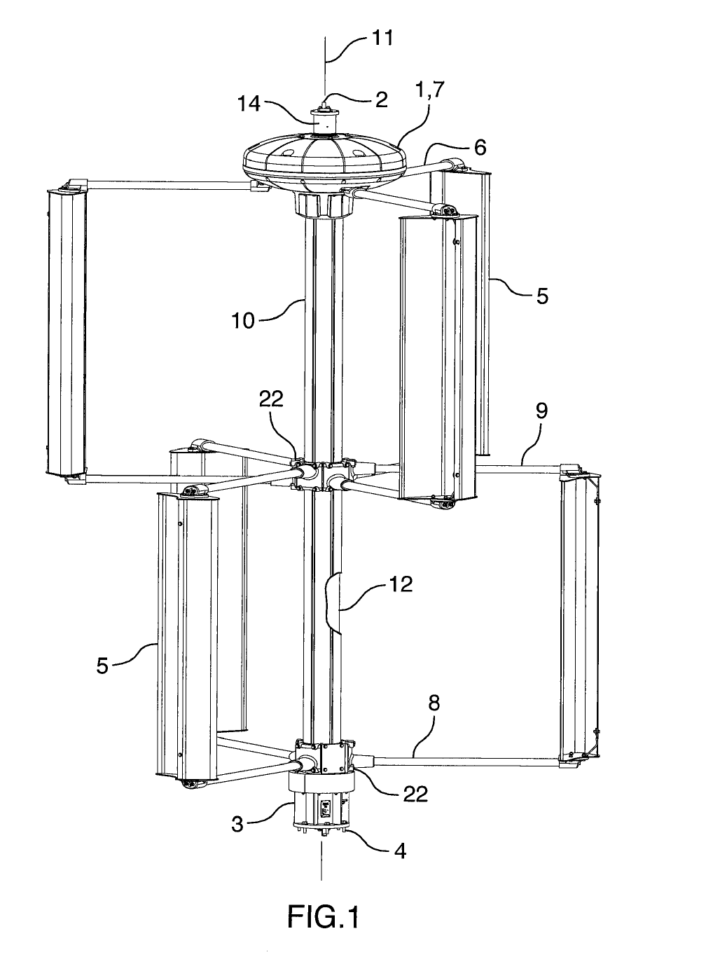

FIG. 1 shows an example embodiment of the invention being a wind turbine with an electrical generator 1 at the top adjacent a lifting lug 2. At the base 3 are several anchor bolts 4 for securing the wind turbine to a foundation or other supporting structure. The wind turbine is driven by blades 5, illustrated as Savonius scoops in the example, having radially extending upper spokes 6 with an inner end secured to the rotor housing 7 of the generator 1. Lower spokes 8 and middle spokes 9 are secured to a hub 22 on the rotor assembly which includes an elongate sleeve 10 to rotate about the vertical axis of rotation 11.

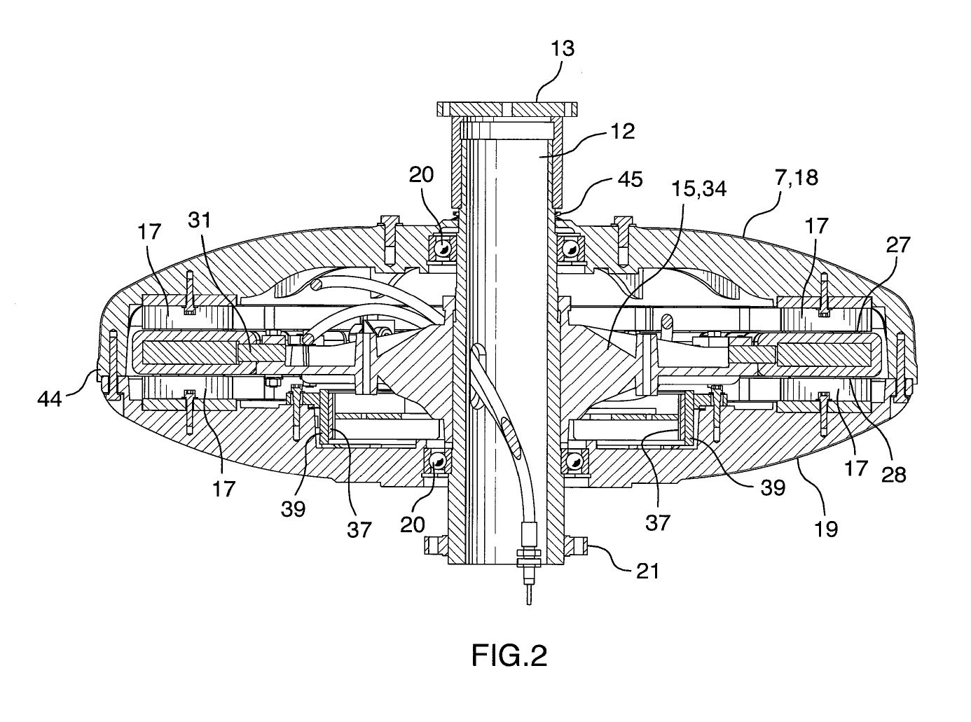

Extending upwardly from the base 3 is a stationary cantilevered spindle 12 inside the sleeve 10 and projecting through the generator 1 as shown in FIG. 2. A top portion of the hollow cantilevered spindle 12 includes a mounting flange 13. Various auxiliary devices can be mounted to the mounting flange 13, such as the lifting lug 2 shown in FIG. 1. Since the hollow spindle 12 can be used as a conduit for wiring, hoses and other equipment, the mounting flange 13 can be used to mount many kinds of auxiliary devices such as: a solar panel; an advertising sign; a roof; a lamp; a public address speaker; an audio alarm; or a surveillance camera. The simple bolted base 4 and mounting flange 13 at the top of the stationary cantilevered spindle 12, about which the rotor assembly rotates, enables the spindle 12 to be used as a structural post or column in many outdoor applications. For convenient installation and removal of the generator 1 for maintenance, FIG. 2 shows an upper portion of the spindle 12 having a flange 21 at a lower end. The flange 21 connects to a matching flange in the lower portion or mast of the spindle 12 to assemble the elongate spindle 12 shown in FIG. 1.

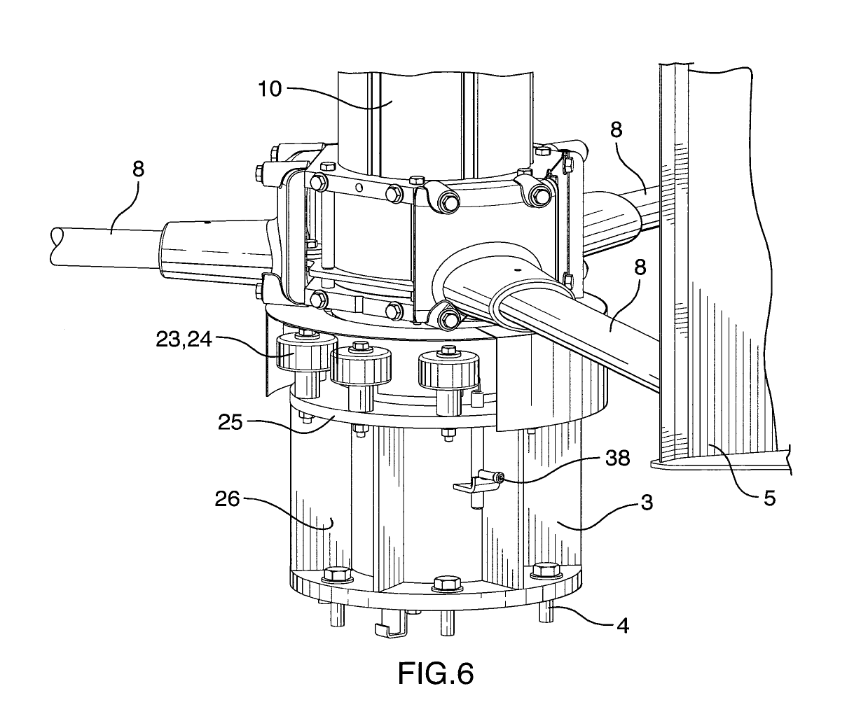

With reference to FIGS. 1 and 6, the wind turbine with an electric generator 1 has a rotor assembly that is mounted to the stationary spindle 12 to rotate about the vertical axis 11. In this specification, the term “rotor assembly” designates all components that are joined together, receive torque forces from the wind and as a result, rotate together about the stationary spindle 12. The cantilevered spindle 12 has an upper end 14 and a lower base 3 for securing the spindle 12 to a support structure (not shown) with bolts 4 for example.

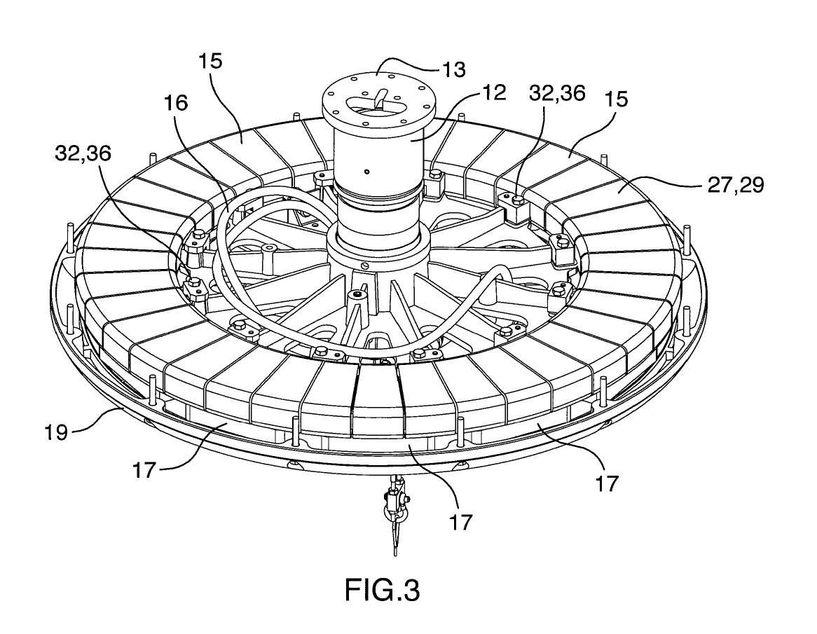

Referring to FIGS. 2-3, the spindle 12 has an electric generator stator 15 disposed about the spindle 12 in communication with electrical conductors 16. The rotating components that rotate together define the rotor assembly including the elongate sleeve 10 (see FIG. 1) and the rotor housing 7 mounted coaxially around the spindle 12 and the stator 15 for rotation about the vertical axis 11 (FIG. 1).

As seen in FIG. 2-3 the rotor housing 7 secures a plurality of electricity generating permanent magnets 17 disposed about the stator 15 mounted in the upper shell 18 and in the lower shell 19 of the rotor housing 7. As best seen in FIG. 2, the rotor assembly also includes rotor bearings 20 rotatably mounting the rotor housing 7 to the spindle 12. FIG. 2 shows an upper portion of the spindle 12 having a flange 21 at a lower end. The flange 21 connects to a matching flange in the lower portion of the spindle 12 to assemble the elongate spindle 12 coaxially mounted inside the sleeve 10 as shown in FIG. 1. The advantage of this arrangement is that the generator 1 with the upper portion of the spindle 12 can be easily removed from the mast or lower portion of the spindle 12 for repair, inspection or replacement. Another advantage of the arrangement is that the blades 5 can be mounted via the upper spokes 6 to bolt sockets in the underside of the lower shell 19 of the rotor housing 7. This enables the rotor bearings 20 of the rotor housing 7 to directly support the blades 5. Using the shells 18, 19 of the rotor housing 7 for multiple purposes results in a simpler design and reduced part count for the rotor assembly. The rotor housing 7 serves to house the electrical components and magnets 17 in a weather resistant enclosure, provides secure mounting for the permanent magnets 17 which exert forces due to magnetic attraction-repulsion as well as centrifugal forces, and also provides structural support for the blades 5.

As seen in FIGS. 1 and 6, the blades 5 include a plurality of radially extending upper spokes 6 having an inner end secured to the rotor housing. The other spokes 8, 9 have their inner ends releasably mounted to hubs 22 on the sleeve 10. In the example illustrated, all of the spokes 6, 8, 9 have an outer end secured to a plurality of Savonius scoops. Other types of wind turbine blades can easily be adapted and mounted with removable bolts to the hubs 22 and lower shell 19 as required by the location and environment of any installation.

The spindle 12 and sleeve 10 are preferably elongate to enable mounting of multiple blades 5 however the invention can also be adapted to relatively short vertical axis wind turbines with a single tier of blades 5, or can be adapted for use in a horizontal axis windmill if required by mounting blades 5 directly on the rotor housing 7. The illustrated embodiment shows the generator 1 disposed a large distance upward from the base 3 however the generator could be located adjacent the base 3 or in the middle area of the sleeve 10 if required. The top location enables simple removal for maintenance and may be preferable in many situations.

As best seen in FIG. 6, the base 3 includes a base bearing 23 made of multiple rubber rollers 24 mounted on a radially extending flange 25 extending from the lower portion of the stationary spindle 12. The rollers 24 engage the sleeve 10 adjacent to the base 3 and permit rotation of the sleeve 10 relative to the spindle 12 and base 3. Since the spindle 12 is a cantilever structure the spindle 12 will deflect laterally under wind loads with a maximum lateral deflection at its top. However the sleeve 10 is supported on bearings at the top and bottom. In the embodiment illustrated the middle spokes 9 exert lateral loads in the middle of the sleeve 10 and therefore the maximum lateral deflection of the sleeve 10 will be in the middle area. The relative lateral deflections of the spindle 12 and sleeve 10 result in some axial movement of the sleeve 10 relative to the base 3 and spindle 12 adjacent the base 3. The use of a simple roller bearing arrangement, as shown, enables limited axial sliding of the sleeve 10 while retaining the rotary support required. The reverse arrangement could also be adopted with rollers 24 mounted on the sleeve 10 instead of the stationary base 3. Therefore in general terms, the base bearing 23 has a plurality of rollers 24 each mounted to at least one of: the base 3; or the sleeve 10 for rotation about their individual roller axes which are each parallel to the vertical axis 11.

In the embodiment shown in FIGS. 6 and 1, the plurality of rollers 24 are mounted to the base 3 and an inner surface of each roller 24 engages a radially outward surface of the sleeve 10. In FIG. 6 an access cover 26 permits access to the hollow interior of the spindle 12 from top to bottom. This enables electrical conductors 16 to be conveniently installed and maintained between the stator 15 and ground level, as well as any equipment needed for any auxiliary device installed on the top of the spindle 12 to the mounting flange 13. Further as described below, the generator includes a drum brake that can be actuated via hydraulics, electric conductors, tension cables or with a mechanical linkage from the ground level using the hollow spindle interior to house any required brake operating equipment.

The electric generator 1 itself will now be described with reference to FIGS. 2-5 primarily. As seen in FIG. 2-3, the stator 15 has a first upper annular flux surface 27 and a second lower annular flux surface 28 transverse the axis of rotation 11. A plurality of armature sections 29 are disposed in a circumferential array (FIG. 3) wherein each armature section 29 has metal wire coils in communication with electrical conductors 16. The stator 15 being fixed to the hollow stationary spindle 12 enables simple wiring between base 3 at ground level and the stator 15 through the interior of the stationary spindle 12.

The term “rotor assembly” includes all rotating components, including the rotor housing 7 enveloping the stator 15 and the rotor housing shells 18, 19 that house the permanent magnets 17. The magnets 17 are arranged in a first upper annular permanent magnet array and a second lower annular permanent magnet array mounted in the rotor housing shells 18, 19 adjacent the first upper flux surface 27 and the second lower flux surface 28 respectively. The first annular permanent magnet array is mounted in the upper shell 18 and the second annular permanent magnet array is mounted in the lower shell 19. The shells 18,19 of the rotor housing 7 are connected to the sleeve 10 mounted on rotor bearings 20 the spindle 12 for rotation about the axis 11.

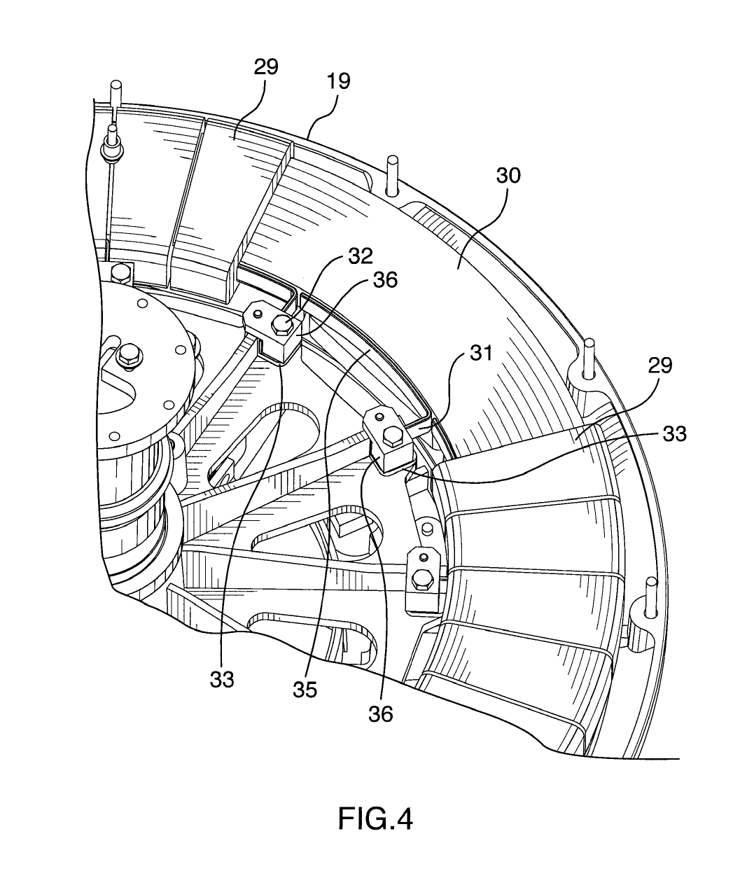

Referring to FIG. 4, each armature section 29 comprises a bobbin segment 30 about which insulated metal wire coils are wound. The bobbin segments 30 include a mounting lug 31 and a fastener including a bolt 32 and clamp block 36 engageable with a matching contact pad 33 in the stator hub 34. The mounting lug 31 illustrated comprises a bent metal plate having a radial portion extending inwardly from the bobbin segment 30 and a circumferential portion 35 positioned within the interior of metal wire coil. The mounting lug 31 is removably secured to the contact pad 33 with a removably fastener assembly including a bolt 32 and a clamp block 36 having a recess in a radial side engageable with the radial portion of the mounting lug 31.

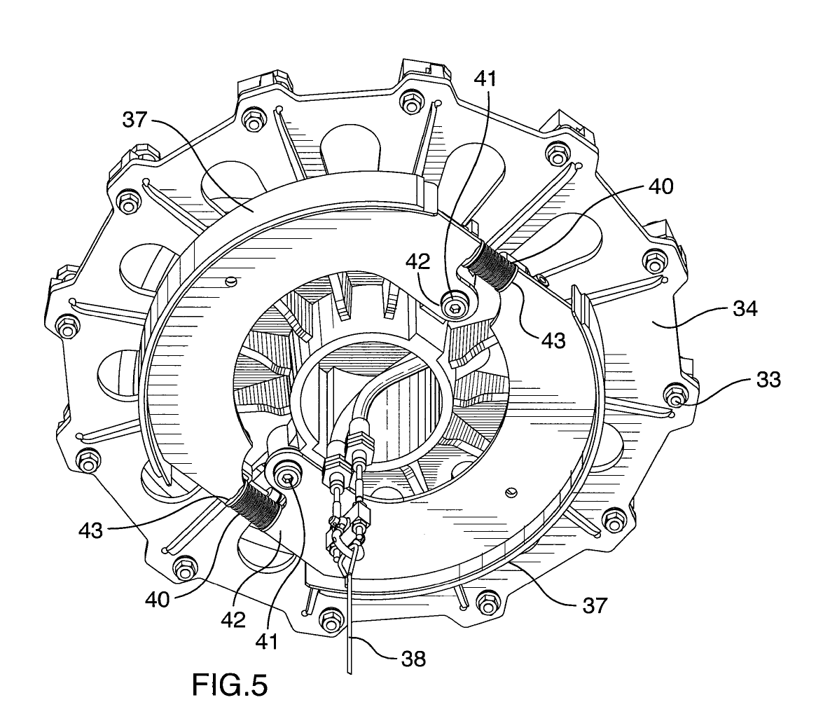

As seen in FIGS. 2 and 5, the electric generator 1 includes a drum brake assembly with at least one brake shoe 37 mounted to the stator hub 34 and moveable in a radial direction with a brake actuator 38. A brake drum 39 (FIG. 2) surrounds the brake shoes 37 and is mounted to the lower shell 19 of the rotor housing 7.

As seen in FIG. 5 the brake shoes 37 are each pivotally mounted to the stator hub 34 with compression springs 40 engaging and biasing the brake shoes 37 into engagement with the brake drum 39. Coil springs, leaf springs or other types of springs could be used to bias the brake shoes 37 in a similar manner. As illustrated the springs 40 are each a compression spring 40 disposed between adjacent brake shoes 37. Each brake shoe 37 is pivotally mounted on a pin 41 to the stator hub 34 at its proximal end, the proximal end including a proximal spring receiving stub 42 disposed a radial distance from the pin 41. A distal end of the brake shoe 37 remote from the pin 41 includes a distal spring receiving stub 43, and each compression spring 40 is mounted to the proximal and distal stubs 42, 43 of the adjacent brake shoe 37. The brake actuator includes a brake actuating control for example behind access cover 26 adjacent the base 3 of the spindle 12.

The rotor housing 7 has an upper shell 18 and a lower shell 19 that have a weather resistant joint 44 therebetween. The upper shell 18 includes a weather resistant seal 45 engaging the spindle 12.

Although the above description relates to a specific preferred embodiment as presently contemplated by the inventor, it will be understood that the invention in its broad aspect includes mechanical and functional equivalents of the elements described herein.

I claim:

1. A wind turbine with an electric generator, having a vertical axis of rotation, the wind turbine comprising:
a cantilevered spindle having an upper end and a lower base for securing to a support structure, the spindle having an electric generator stator disposed about the spindle in communication with electrical conductors;
a rotor assembly comprising a sleeve and a rotor housing mounted coaxially around the spindle and the stator for rotation about the vertical axis, the rotor housing having a plurality of permanent magnets disposed about the stator mounted in the rotor housing, the rotor assembly including rotor bearings mounting the rotor housing to the spindle; and
a plurality of blades mounted to the rotor housing.

2. The wind turbine of claim 1 wherein the blades include a plurality of radially extending spokes having an inner end secured to the rotor housing.

3. The wind turbine of claim 2 wherein the spokes have an outer end secured to a plurality of Savonius scoops.

4. The wind turbine of claim 1 wherein the spindle and sleeve are elongate, wherein the generator is disposed a distance upward from the base, the base including a base bearing engaging the spindle and the sleeve adjacent to the base.

5. The wind turbine of claim 4 wherein the base bearing comprises a plurality of rollers each mounted to at least one of: the base; and the sleeve for rotation about a roller axis parallel to the vertical axis.

6. The wind turbine of claim 5 wherein the plurality of rollers are mounted to the base and wherein an inner surface of each roller engages a radially outward surface of the sleeve.

7. The wind turbine of claim 1 wherein the spindle is a hollow tube.

8. The wind turbine of claim 1 wherein the upper end of the spindle includes a mounting flange.

9. The wind turbine of claim 8 wherein the spindle includes an auxiliary device mounted to the mounting flange, the auxiliary device selected from the group consisting of: a solar panel; an advertising sign; a roof; a lamp; a public address speaker; an audio alarm; a surveillance camera; and a lifting lug.

10. An electric generator having an axis of rotation comprising:
a stator having a first annular flux surface and a second annular flux surface transverse the axis of rotation and a plurality of armature sections disposed in a circumferential array wherein each armature section has metal wire coils in communication with electrical conductors, the stator being fixed to a spindle;
a rotor assembly comprising a rotor housing enveloping the stator, the rotor assembly having a first annular permanent magnet array and a second annular permanent magnet array mounted in the rotor housing adjacent the first flux surface and the second flux surface respectively, the rotor housing connected to a sleeve mounted on the spindle for rotation about the axis;
wherein each armature section comprises a bobbin segment about which at least one of the metal wire coils are wound, the bobbin segment including a mounting lug and fastener engageable with a matching contact pad in a stator hub.

11. The electric generator of claim 10 wherein the mounting lug comprises a bent metal plate having a radial portion extending inwardly from the bobbin segment and a circumferential portion positioned within the metal wire coil.

12. The electric generator of claim 11 wherein the mounting lug is removably secured to the contact pad with a fastener comprising a bolt and a clamp block having a recess in a radial side engageable with the radial portion of the mounting lug.

13. The electric generator of claim 10 including a drum brake comprising:
a brake shoe mounted to a stator hub and moveable in a radial direction with a brake actuator; and
a brake drum surrounding the brake shoe and mounted to the rotor housing.

14. The electric generator of claim 13 comprising a plurality of brake shoes each pivotally mounted to the stator hub and a plurality of springs, each spring engaging a brake shoe and biasing the brake shoe into engagement with the brake drum.

15. The electric generator of claim 14 wherein the plurality of springs are each a compression spring disposed between adjacent brake shoes.

16. The electric generator of claim 15 wherein each brake shoe is pivotally mounted on a pin to the stator hub at a proximal end, the proximal end including a proximal spring receiving stub disposed a radial distance from the pin, a distal end of the brake shoe remote from the pin includes a distal spring receiving stub, and each compression spring is mounted to the proximal and distal stubs of said adjacent brake shoes.

17. The electric generator of claim 13 wherein the brake actuator includes a brake actuating control adjacent a base of the spindle.

18. The electric generator of claim 10 wherein the generator has a vertical axis of rotation and the rotor housing comprises an upper shell and a lower shell having a weather resistant joint therebetween.

19. The electric generator of claim 18 wherein the first annular permanent magnet array is mounted in the upper shell and the second annular permanent magnet array is mounted in the lower shell.

20. The electric generator of claim 18 wherein the upper shell includes a weather resistant seal engaging the spindle.
